(19) United States
(12) Patent Application Publication
(10) Pub. No.: US 2005/0255364 A1
(43) Pub. Date: Nov. 17, 2005

(54) Bipolar plate of fuel cell

(76) Inventors: Tae-Hee Cho, Gyeongsangnam-Do (KR); Myung-Seok Park, Gyeongsangnam-Do (KR); Hong Choi, Gyeongsangnam-Do (KR); Kyu-Jung Kim, Gyeonggi-Do (KR); Myeong-Ho Lee, Busan (KR); Cheol-Hwan Kim, Gyeongsangnam-do (KR); Yong-Jun Hwang, Gyeongsangnam-Do (KR); Seung-Tae Ko, Daegu (KR); Seong-Geun Heo, Busan (KR)

Correspondence Address: FLESHNER & KIM, LLP, P.O. BOX 221200, CHANTILLY, VA, 20153, US

(21) Appl. No.: 10/484,164

(22) PCT Filed: Dec. 12, 2003
(86) PCT No.: PCT/KR03/02729

§ 371 Date: Jan. 20, 2004

(51) Int. Cl. H01M 8/02

(52) U.S. Cl. 429/38; 429/39

(57) ABSTRACT

In a bipolar plate of a fuel cell including a plate having a certain area and thickness; inflow and outflow buffer grooves respectively formed at both sides of the plate so as to have a certain area and depth; plural channels for connecting the inflow buffer groove and the outflow buffer groove; plural buffer protrusions formed in the inflow and outflow buffer grooves so as to have a certain height; an inflow path formed on the plate so as to be connected to the inflow buffer groove; and an outflow path formed on the plate so as to be connected to the outflow buffer groove, it is possible to uniformize flux distribution and reduce flow resistance of fuel and air respectively flowing into a fuel electrode and an air electrode of a fuel cell.

### TECHNICAL FIELD

The present invention relates to a fuel cell, and in particular to a bipolar plate of a fuel cell capable of uniformizing flux distribution and reducing flow resistance of fuel and air respectively flowing into a fuel electrode (anode) and an air electrode (cathode) of a fuel cell.

### BACKGROUND ART

A fuel cell is generally environment-friendly energy, and it has been developed in order to substitute for the conventional fossil energy. As depicted in FIG. 1, the fuel cell includes a stack to be combined with at least one unit cell 11 in which electron-chemical reaction occurs; a fuel supply pipe 20 connected to the stack 10 so as to supply fuel; an air supply pipe 30 connected to the stack 10 so as to supply air; and discharge pipes 40, 50 for discharging by-products of fuel and air passing the reaction respectively. The unit cell 11 includes a fuel electrode (anode) (not shown) in which fuel flows; and an air electrode (cathode) (not shown) in which air flows.

The operation of the fuel cell will be described.

First, fuel and air are supplied to the fuel electrode and the air electrode of the stack 10 through the fuel supply pipe 20 and the air supply pipe 30 respectively. Fuel supplied to the fuel electrode is ionized into positive ions and electrons (e-) through electrochemical oxidation reaction in the fuel electrode, the ionized positive ions are moved to the air electrode through an electrolyte layer, and the electrons are moved to the fuel electrode. The positive ions moved to the air electrode perform electrochemical reduction reaction with air supplied to the air electrode and generate by-products such as reaction heat and water, etc. In the process, by the movement of the electrons, electric energy is generated. The fuel through the reaction in the fuel electrode, and water and additional by-products generated in the air electrode are respectively discharged through the discharge lines 40, 50.

The fuel cell can be classified into various types according to kinds of electrolyte and fuel, etc. used therein.

In the meantime, as depicted in FIG. 2, the unit cell 11 constructing the stack 10 includes two bipolar plates 100 having an open channel 101 in which air or fuel flows; and a M.E.A (membrane electrode assembly) 110 arranged between the two bipolar plates 100 so as to have a certain thickness and area. The two bipolar plates 100 and the M.E.A 110 arranged therebetween are combined with each other by additional combining means 120, 121. A channel formed by a channel 101 of the bipolar plate 100 and a side of the M.E.A 110 constructs a fuel electrode, and oxidation reaction occurs while fuel flows through the channel of the fuel electrode. And, a channel formed by a channel 101 of the other bipolar plate 100 and the other side of the M.E.A 110 constructs an air electrode, and reduction reaction occurs while air flows through the channel of the air electrode.

A shape of the bipolar plate 100, in particular, a shape of the channel 101 affects contact resistance generated in flowing of fuel and air and flux distribution, etc., and contact resistance and flux distribution affect power efficiency. And, the bipolar plates 100 have a certain shape appropriate to processing facilitation and mass production.

As depicted in FIG. 3, in the conventional first bipolar plate, through holes 131, 132, 133, 134 are respectively formed at each edge of the plate 130 having a certain thickness and a rectangular shape. Among the four through holes, the diagonally arranged two through holes 131, 133 are fuel paths, and the diagonally arranged two through holes 132, 134 are air paths. Hexagonal channel 135 in which a fluid flows is respectively formed at both sides of the plate 130, and plural straight channels 136 are horizontally formed along the whole internal area of the hexagonal channel 135. And, the hexagonal channel 135 formed at the side of the plate 130 and the plural straight connection channels 136 are connected to the diagonally arranged two through holes 131, 133 through plural straight channels 137. And, the hexagonal channel 135 formed at the other side of the plate 130 and the plural straight channels 136 are connected to the diagonally arranged two through holes 132, 134 through plural straight connection channels 137. In more detail, in the plate 130, fuel flows on the side, and air flows on the other side.

FIG. 3 is a plane view illustrating a side of the conventional bipolar plate.

The operation of the conventional bipolar plate will be described. Fuel or air flows into the through holes 131, 132, the fuel or air flows into the hexagonal channel 135 and the plural straight channels 136 through the connection channels 137, and it flows into the connection channels at the other side. The fuel or air flowing into the connection channels 137 are discharged through the through holes 133, 134 at the other side.

In the meantime, in another structure of the conventional second bipolar plate, as depicted in FIG. 4, through holes 141, 142, 143, 144 are respectively formed at edges of the plate 140 having a certain thickness and a rectangular shape. And, curved plural channels 145 are formed on a side of the plate 140 so as to connect the diagonally arranged two through holes 141, 143. And, curved plural channels 145 are formed on the other side of the plate 140 so as to connect the diagonally arranged two through holes 142, 144.

The operation of the second bipolar plate will be described. Fuel and air respectively flow into the through holes 141, 142, fuel or air respectively flowing into the through holes 141, 142 passes the plural channels 145 and is discharged through the other through holes 143, 144.

However, in the conventional first bipolar plate, because the number of the connection channels 137 for connecting the through holes 131, 132, 133, 134, the hexagonal channel 135 and the straight channels 136 is very little in comparison with the number of the straight channels 136 formed in the hexagonal channel, flux distribution of a fluid flowing into the through holes 131, 132 is not good, and it is inappropriate to using the conventional first bipolar plate in flowing of great amount of fluid. In the meantime, in the conventional second bipolar plate, because the channels 145 of fuel and air are formed as a curved shape, flow resistance is increased in flowing of fuel and air, and accordingly pressure loss for flowing the fluid is increased.

### TECHNICAL GIST OF THE PRESENT INVENTION

In order to solve the above-mentioned problems, it is an object of the present invention to provide a bipolar plate of a fuel cell capable of uniformizing flux distribution and reducing flow resistance of fuel and air respectively flowing into a fuel electrode and an air electrode.

In order to achieve the above-mentioned object, a bipolar plate of a fuel cell in accordance with the present invention includes a plate having a certain area and thickness; inflow and outflow buffer grooves respectively formed at both sides of the plate so as to have a certain area and depth; plural channels for connecting the inflow buffer groove and the outflow buffer groove; an inflow path formed on the plate so as to be connected to the inflow buffer groove; and an outflow path formed on the plate so as to be connected to the outflow buffer groove.

In addition, a bipolar plate of a fuel cell in accordance with the present invention includes a plate having a certain area and thickness; inflow and outflow buffer grooves respectively formed at both sides of the plate so as to have a certain area and depth; plural channels for connecting the inflow buffer groove and the outflow buffer groove; plural buffer protrusions formed in the inflow and outflow buffer grooves so as to have a certain height; an inflow path formed on the plate so as to be connected to the inflow buffer groove; and an outflow path formed on the plate so as to be connected to the outflow buffer groove.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows the conventional fuel cell system;

FIG. 2 is an exploded-perspective view illustrating a stack of the conventional fuel cell;

FIG. 3 is a plane view illustrating an example of a bipolar plate of the conventional fuel cell;

FIG. 4 is a plane view illustrating another example of a bipolar plate of the conventional fuel cell;

FIG. 5 is a plane view illustrating a first embodiment of a bipolar plate of a fuel cell in accordance with the present invention;

FIG. 6 is a sectional view taken along a line A-B in FIG. 5;

FIGS. 7 and 8 are plane views respectively illustrating channels of the bipolar plate of the fuel cell in accordance with the first embodiment of the present invention;

FIG. 9 is a plane view illustrating distribution means of the bipolar plate of the fuel cell in accordance with the first embodiment of the present invention;

FIG. 10 is a plane view illustrating a second embodiment of a bipolar plate of a fuel cell in accordance with the present invention;

FIG. 11 is a sectional view taken along a line C-D in FIG. 10;

FIGS. 12 and 13 are plane views respectively illustrating modifications of buffer protrusions of the bipolar plate of the fuel cell in accordance with the second embodiment of the present invention;

FIGS. 14 and 15 are plane views respectively illustrating other examples of channels of the bipolar plate of the fuel cell in accordance with the second embodiment of the present invention;

FIG. 16 is a plane view illustrating distribution means of the bipolar plate of the fuel cell in accordance with the second embodiment of the present invention;

FIG. 17 is an exploded-perspective view illustrating a stack of the bipolar plate of the fuel cell in accordance with the second embodiment of the present invention;

FIG. 18 is a plane view illustrating an operational state of the bipolar plate of the fuel cell in accordance with the first embodiment of the present invention; and

FIG. 19 is a plane view illustrating an operational state of the bipolar plate of the fuel cell in accordance with the second embodiment of the present invention.

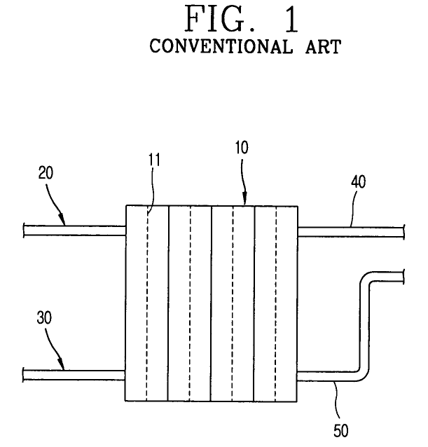

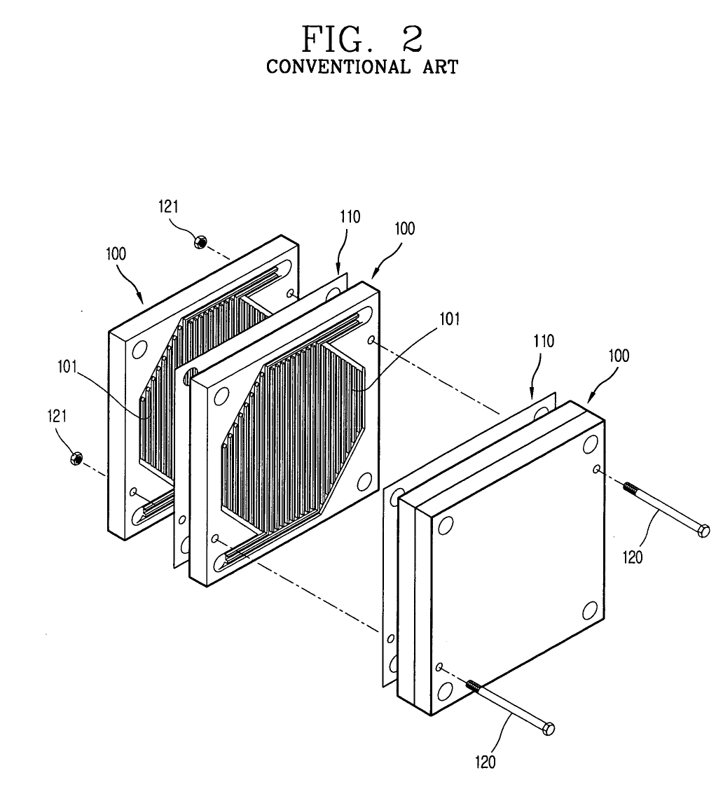

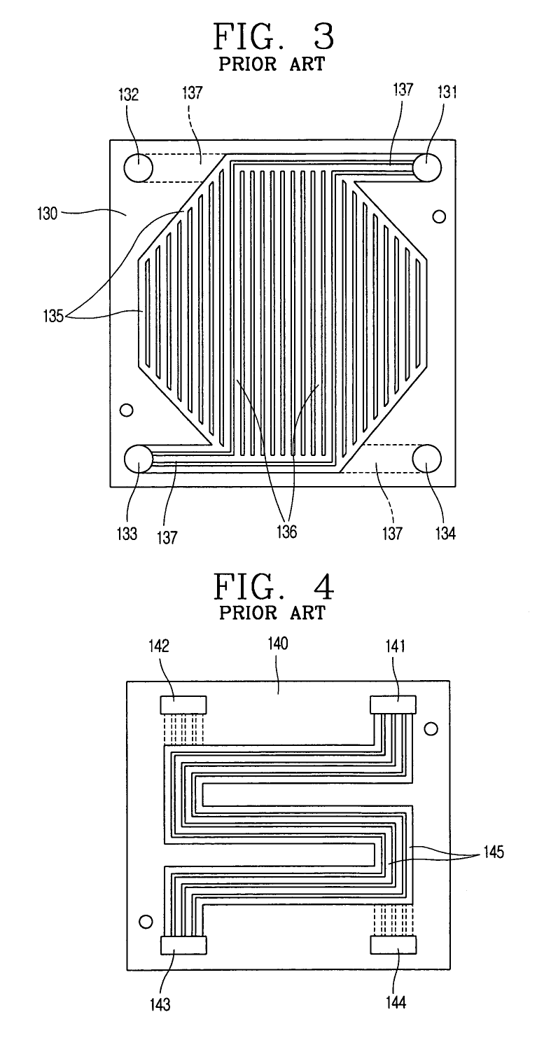

### DETAILED DESCRIPTION OF THE INVENTION

Hereinafter, the preferred embodiments of a bipolar plate of a fuel cell in accordance with the present invention will be described with reference to accompanying drawings.

First, a first embodiment of a bipolar plate of a fuel cell in accordance with the present invention will be described.

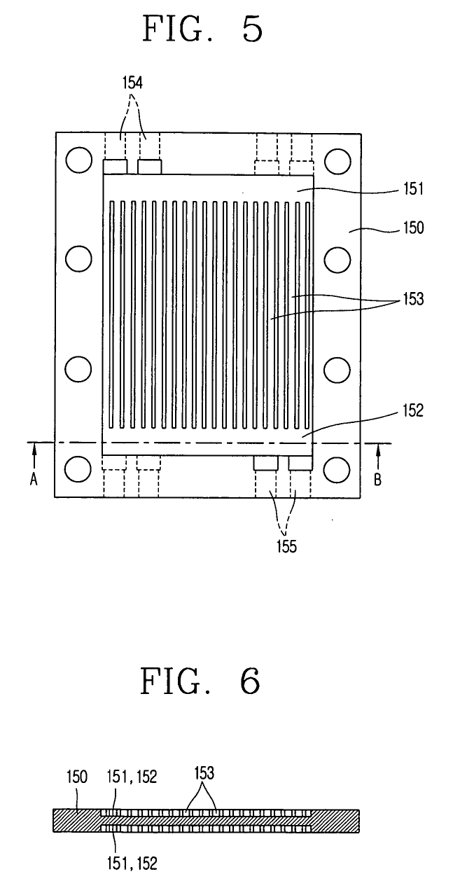

FIG. 5 is a plane view illustrating a first embodiment of a bipolar plate of a fuel cell in accordance with the present invention, and FIG. 6 is a sectional view taken along a line A-B in FIG. 5.

As depicted in FIGS. 5 and 6, the bipolar plate of the fuel cell in accordance with the present invention includes a plate 150 having a certain area and thickness; inflow and outflow buffer grooves 151, 152 respectively formed at both sides of the plate 150 so as to have a certain area and depth; plural channels 153 for connecting the inflow buffer groove 151 and the outflow buffer groove 152; an inflow path 154 formed on the plate 150 so as to be connected to the inflow buffer groove 151; and an outflow path 155 formed on the plate 150 so as to be connected to the outflow buffer groove 152.

The plate 150 is formed as a rectangular shape and has a uniform thickness. The inflow buffer groove 151 is formed as a rectangular shape having a certain width and length, and it has the uniform depth. Width and length of the outflow buffer groove 152 are the same with those of the inflow buffer groove 151, and the outflow buffer groove 152 has the uniform depth. The inflow buffer groove 151 and the outflow buffer groove 152 are arranged on the same line and have the same depth.

The inflow buffer groove 151 and the outflow buffer groove 152 can have other shapes besides the rectangular shape and have different depth.

And, plural channels 153 are formed between the inflow buffer groove 151 and the outflow buffer groove 152 in order to connect them. The channels 153 are straight and have the uniform width. In addition, the channels 153 have the same depth with the inflow buffer groove 151 and the outflow buffer groove 152.

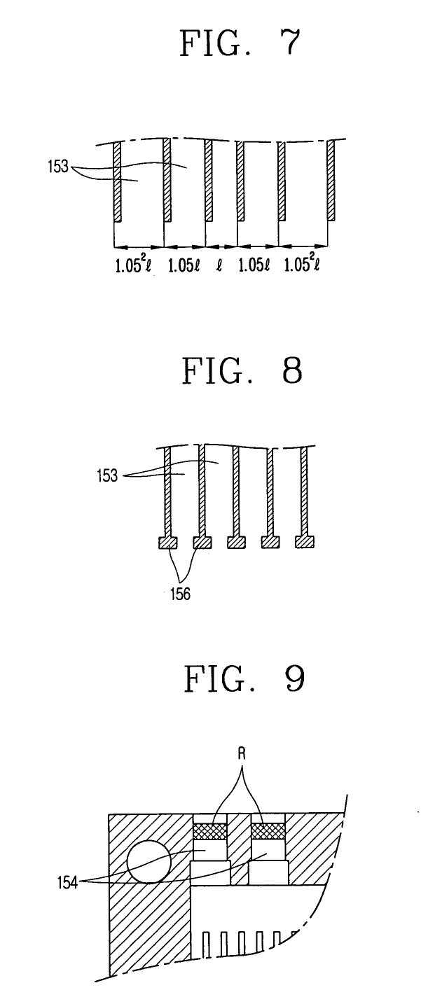

In the meantime, as depicted in FIG. 7, in another example of the channels 153, channel width is increased gradually from the channel 153 arranged on the middle to the channel 153 arranged on the edge. In more detail, in order to distribute the fluid in the inflow buffer groove 151 to the channels 153 evenly, width of the middle channel is narrower, width of the edge channel is wider, and width of each channel is linearly increased.

As depicted in FIG. 8, in yet another example of the channels 153, the channels 153 have the same width, and a buffer portion 156 is formed at the inlet side of each channel 153 so as to reduce a width of the inlet. The buffer portion 156 is a protrusion extended-projected from both walls constructing the channel 153. The buffer portion 156 is for distributing the fluid flowing into the inflow buffer groove 151 to the channels 153 uniformly.

The length of the inflow buffer groove 151 and the outflow buffer groove 152 is not less than ⅕ of the length of the channel 153.

The inflow buffer channel 154 is formed at a side of the plate 150 so as to be arranged on the length line of the channels 153. The inflow path 154 is constructed as at least one through hole.

The outflow path 155 is formed at a side of the plate 150 so as to be arranged on the length line of the channels 153 and on the opposite side of the inflow path 154. The outflow path 155 is formed as at least through hole.

And, as depicted in FIG. 9, a distribution means (R) for giving flow resistance to the fluid flowing into the inflow path 154 can be arranged in the inflow path 154.

The distribution means (R) is formed as a shape having an area corresponded to the section of the inflow path 154 and a certain thickness and is made of a porous material. The distribution means (R) uniformizes distribution of the fluid flowing into each unit cell by inducing flow resistance of the fluid flowing into the inflow path 154.

When the bipolar plate of the fuel cell in accordance with the first embodiment of the present invention constructs a unit cell or is arranged on both sides of a stack, the inflow buffer groove 151, the outflow buffer groove 152 and the plural channels 153, etc. are formed only on one side of the plate 150.

Next, a bipolar plate of a fuel cell in accordance with a second embodiment of the present invention will be described.

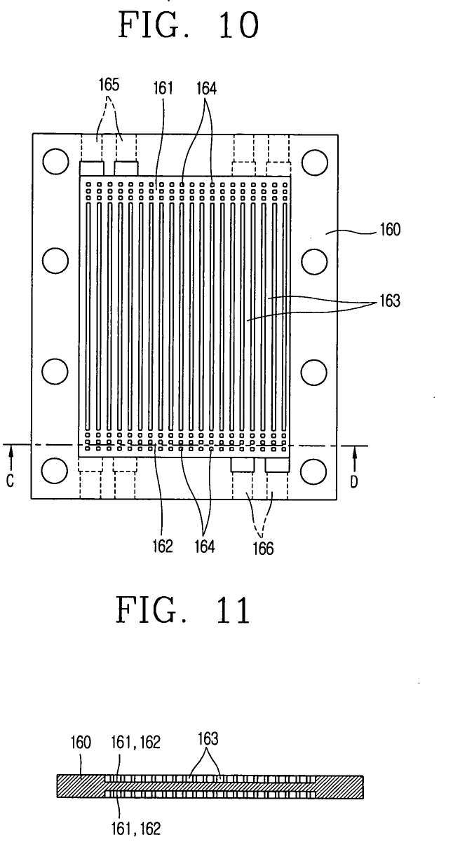

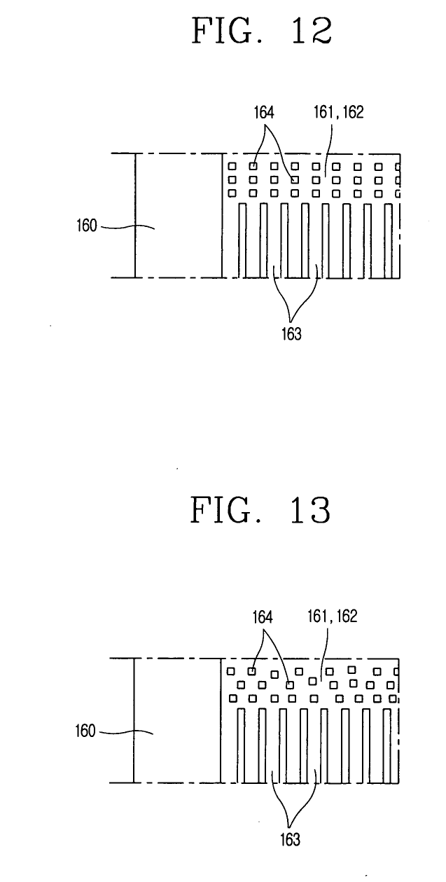

FIG. 10 is a plane view illustrating a second embodiment of a bipolar plate of a fuel cell in accordance with the present invention, and FIG. 11 is a sectional view taken along a line C-D in FIG. 10.

As depicted in FIGS. 10 and 11, the bipolar plate of the fuel cell in accordance with the second embodiment of the present invention includes a plate 160 having a certain area and thickness; inflow and outflow buffer grooves 161, 162 respectively formed at both sides of the plate 160 so as to have a certain area and depth; plural channels 163 for connecting the inflow buffer groove 161 and the outflow buffer groove 162; plural buffer protrusions 164 formed in the inflow and outflow buffer grooves 161, 162 so as to have a certain height; an inflow path 165 formed on the plate 160 so as to be connected to the inflow buffer groove 161; and an outflow path 166 formed on the plate 160 so as to be connected to the outflow buffer groove 162.

The plate 160 is formed as a rectangular shape and has a uniform thickness. The inflow buffer groove 161 is formed as a rectangular shape having a certain width and length, and it has the uniform depth. Width and length of the outflow buffer groove 162 are the same with those of the inflow buffer groove 161, and the outflow buffer groove 152 has the uniform depth. The inflow buffer groove 161 and the outflow buffer groove 162 are arranged on the same line and have the same depth.

Plural channels 163 are formed between the inflow buffer groove 161 and the outflow buffer groove 162 in order to connect them. The channels 163 are straight and have the same depth with the inflow and outflow buffer grooves 161, 162. A length of the inflow and outflow buffer grooves 161, 162 is not less than ⅕ of the length of the channel 163.

The buffer protrusions 164 are linearly formed between the channels 163.

As depicted in FIG. 12, the buffer protrusions 164 having a modified shape are linearly arranged on the channels 163.

The buffer protrusions 164 have the same height. The height of the buffer protrusion is the same with the depth of the inflow buffer groove 161 or the outflow buffer groove 162.

A section of the buffer protrusion 164 is rectangular. A section of the buffer protrusion 164 can be other shapes besides a rectangular shape.

As depicted in FIG. 13, as a modified form, the buffer protrusions 164 are irregularly arranged.

The inflow and outflow buffer grooves 161, 162 can have other shapes besides a rectangular shape and can have different depth.

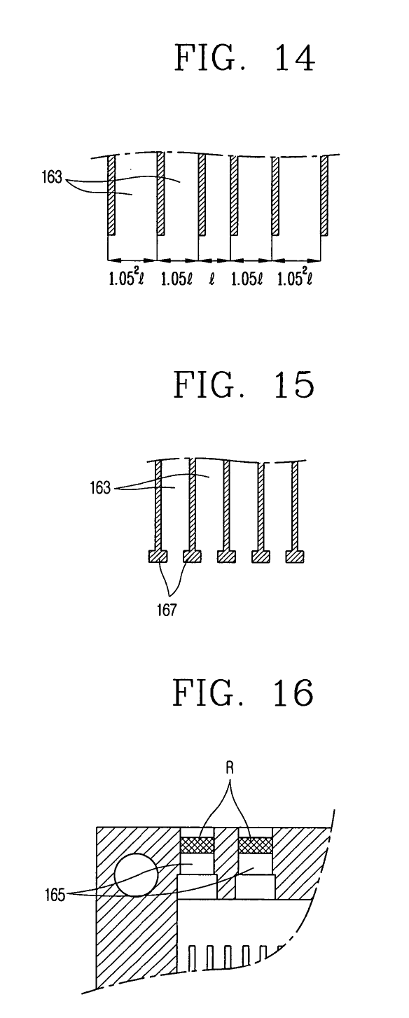

In the meantime, as depicted in FIG. 14, in another example of the channels 163, channel width is increased gradually from the channel 163 arranged on the middle to the channel 163 arranged on the edge. In more detail, in order to distribute the fluid in the inflow buffer groove 161 to the channels 163 uniformly, width of the middle channel is narrower, width of the edge channel is wider, and width of each channel is linearly increased.

As depicted in FIG. 15, in yet another example of the channels 163, the channels 163 have the same width, and a buffer portion 167 is formed at the inlet side of each channel 163 so as to reduce a width of the inlet. The buffer portion 167 is a protrusion extended-projected from both walls constructing the channel 163. The buffer portion 167 is for distributing the fluid flowing into the inflow buffer groove 161 to the channels 163 uniformly.

The inflow buffer channel 165 is formed at a side of the plate 160 so as to be arranged on the length line of the channels 163. The inflow path 165 is constructed as at least one through hole.

The outflow path 166 is formed at a side of the plate 160 so as to be arranged on the length line of the channels 163 and on the opposite side of the inflow path 165. The outflow path 166 is formed as at least through hole.

And, as depicted in FIG. 16, a distribution means (R) for giving flow resistance to the fluid flowing into the inflow path 165 can be arranged in the inflow path 165.

The distribution means (R) is formed as a shape having an area corresponded to the section of the inflow path 165 and a certain thickness and is made of a porous material. The distribution means (R) uniformizes distribution of the fluid flowing into each unit cell by inducing flow resistance of the fluid flowing into the inflow path 165.

When the bipolar plate of the fuel cell in accordance with the second embodiment of the present invention constructs a unit cell or is arranged on both sides of a stack, the inflow buffer groove 161, the outflow buffer groove 162, the buffer protrusions 164 and the plural channels 163, etc. are formed only on one side of the plate 160.

Hereinafter, operational advantages of the bipolar plate of the fuel cell in accordance with the present invention will be described.

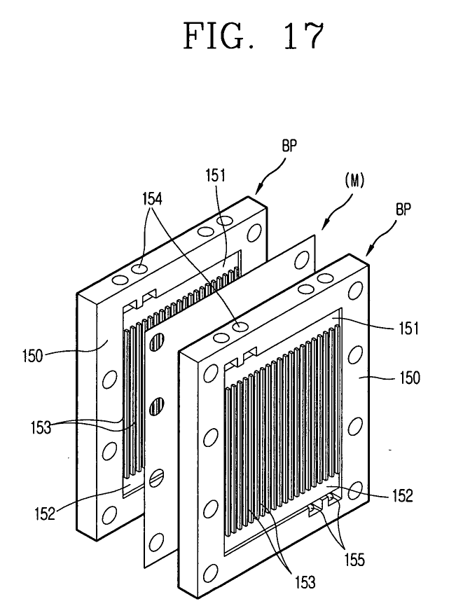

First, in the bipolar plate of the fuel cell in accordance with the present invention, bipolar plates construct a stack of a fuel cell. In more detail, as depicted in FIG. 17, a M.E.A (M) is arranged between the bipolar plates (BP), they are combined with each other by a combining means (not shown), and accordingly a stack of a fuel cell is constructed. Herein, the fuel channel in which fuel flows is formed by the inflow buffer groove 151, the channels 153 and the outflow buffer groove 152, etc formed on one side of the bipolar plate (BP) and one side of the M.E.A (M). And, the air channel in which air flow is formed by the inflow buffer groove 151 formed on the other side of the M.E.A (M) and the inflow buffer groove 151, the channels 153 and the outflow buffer groove 152, etc formed on one side of the other bipolar plate (BP) facing the bipolar plate (BP).

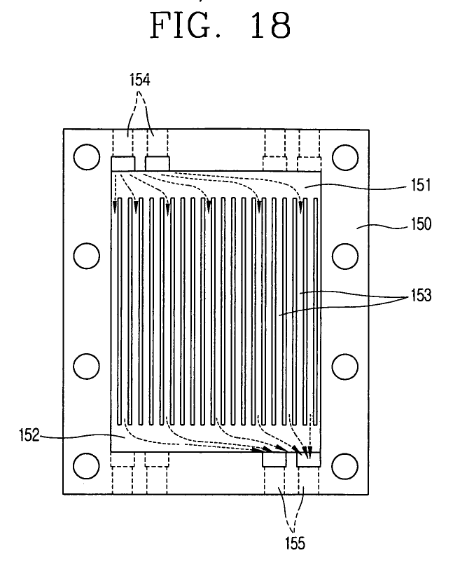

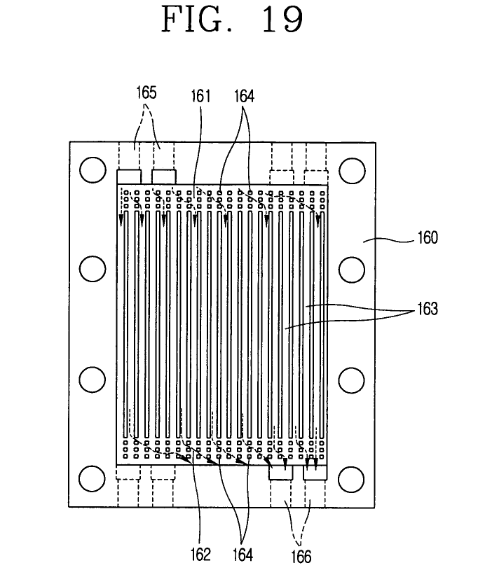

In the structure, when the fuel flows into the inflow path 154 of the bipolar plate (BP), as depicted in FIG. 18, the flow in the inflow path 154 flows into the inflow buffer groove 151. And, the fuel in the inflow buffer groove 151 spreads all over the inflow buffer groove 151 and flows into the channels 153. The fuel in the channels 153 flows into the outflow buffer groove 152 and is discharged to the outside through the outflow path 155. In that process, because the fuel from the inflow path 154 flows into the channels 153 after passing the inflow buffer groove 151, flux is evenly distributed to the all channels 153, and accordingly flowing can be smooth. In addition, the fuel flowing through the channels 153 is gathered in the outflow buffer groove 152 and is discharged to the outside through the outflow path 155, and accordingly flowing of the fuel can be smooth.

In addition, air flows by passing the above-mentioned process.

In the bipolar plate of the fuel cell in accordance with the second embodiment of the present invention, as depicted in FIG. 19, the fuel flows into the inflow buffer groove 161 through the inflow path 165. The fuel in the inflow buffer groove 161 spreads generally by the inflow buffer groove 161 and the buffer protrusions 164 arranged in the inflow buffer groove 161 and is distributed evenly to the channels 163. The fuel flowing through the channels 163 is gathered in the outflow buffer groove 162 and is discharged to the outside through the outflow path 166. In the structure, by the buffer protrusions 164, the fuel is distributed to the channels 163 more evenly, area contacted-supported with the M.E.A (M) between the bipolar plates (BP) is broadened, and accordingly deformation of the M.E.A (M) can be minimized.

In the meantime, in the bipolar plate of the fuel cell in accordance with the present invention, by forming the channels 153, 163 linearly, processing can be easier, and processing methods can be diversified.

### INDUSTRIAL APPLICABILITY

As described-above, in the bipolar plate of the fuel cell in accordance with the present invention, by distributing evenly flux of fuel and air respectively flowing in the fuel electrode and the air electrode, effective area of oxidation reaction and reduction reaction is increased, and power efficiency can be improved. By reducing flow resistance of fuel and air, pumping power for flowing fuel and air is reduced, and efficiency of a fuel cell can be improved. In addition, by facilitating processing and diversifying processing methods, a production cost can be reduced.

1. A bipolar plate of a fuel cell, comprising:
a plate having a certain area and thickness;
inflow and outflow buffer grooves respectively formed at both sides of the plate so as to have a certain area and depth;
plural channels for connecting the inflow buffer groove and the outflow buffer groove;
an inflow path formed on the plate so as to be connected to the inflow buffer groove; and
an outflow path formed on the plate so as to be connected to the outflow buffer groove.

2. The bipolar plate of claim 1, wherein the channels are linearly formed.

3. The bipolar plate of claim 2, wherein channel width is increased gradually from a channel arranged on the middle to a channel arranged on the edge.

4. The bipolar plate of claim 2, wherein width of the channels is uniform, and a projected buffer portion is formed at an inlet side of each channel so as to reduce a width of the inlet.

5. The bipolar plate of claim 1, wherein the inflow path and the outflow path is respectively constructed as at least one through hole.

6. The bipolar plate of claim 1, wherein the inflow path and the outflow path are formed at a side of the plate.

7. The bipolar plate of claim 1, wherein a distribution means is formed in the inflow path in order to give flow resistance to a fluid flowing into the inflow path.

8. The bipolar plate of claim 7, wherein the distribution means is formed as a shape having an area corresponded to the section of the inflow path and a certain thickness, and it is made of a porous material.

9. A bipolar plate of a fuel cell, comprising:
a plate having a certain area and thickness;
inflow and outflow buffer grooves respectively formed at both sides of the plate so as to have a certain area and depth;
plural channels for connecting the inflow buffer groove and the outflow buffer groove;
plural buffer protrusions formed in the inflow and outflow buffer grooves so as to have a certain height;
an inflow path formed on the plate so as to be connected to the inflow buffer groove; and
an outflow path formed on the plate so as to be connected to the outflow buffer groove.

10. The bipolar plate of claim 9, wherein the buffer protrusions are linearly arranged between the channels.

11. The bipolar plate of claim 9, wherein the buffer protrusions are linearly arranged on the channels.

12. The bipolar plate of claim 9, wherein the buffer protrusions are irregularly arranged.

13. The bipolar plate of claim 9, wherein the buffer protrusions have the same height, and the height of the buffer protrusion is the same with the depth of the inflow buffer groove or the outflow buffer groove.

14. The bipolar plate of claim 9, wherein the buffer protrusion has a rectangular section.

15. The bipolar plate of claim 9, wherein the channels are linearly formed.

16. The bipolar plate of claim 15, wherein channel width is increased gradually from a channel arranged on the middle to a channel arranged on the edge.

17. The bipolar plate of claim 15, wherein width of the channels is uniform, and a projected buffer portion is formed at an inlet side of each channel so as to reduce a width of the inlet.

18. The bipolar plate of claim 9, wherein the length of the inflow buffer groove and the outflow buffer groove is not less than ⅕ of the length of the channel.

19. The bipolar plate of claim 9, wherein a distribution means is formed in the inflow path in order to give flow resistance to a fluid flowing into the inflow path.

20. The bipolar plate of claim 19, wherein the distribution means is formed as a shape having an area corresponded to the section of the inflow path and a certain thickness, and it is made of a porous material.
